(19) United States
(12) Patent Application Publication
(10) Pub. No.: US 2009/0179803 A1
(43) Pub. Date: Jul. 16, 2009

(54) Dual-band antenna

(75) Inventors: Tiao-Hsing Tsai, Tao Yuan Shien (TW); Chao-Chiang Kuo, Tao Yuan Shien (TW); Cheng-Hsiung Wu, Tao Yuan Shien (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Quanta Computer Inc., Tao Yuan Shien (TW)

(21) Appl. No.: 12/283,019

(22) Filed: Sep. 8, 2008

(30) Foreign Application Priority Data
Jan. 16, 2008 (TW) 097101647

(51) Int. Cl. H01Q 1/38

(52) U.S. Cl. 343/700 MS

(57) ABSTRACT

An antenna includes first and second radiating elements and a grounding element. The first radiating element is operable in a first frequency range and has a feeding end. The second radiating element is operable in a second frequency range, is connected to the feeding end of the first radiating element, and cooperates with the first radiating element so as to define a slot therebetween such that the second radiating element is coupled to the first radiating element. The grounding element extends from the first radiating element.

### CROSS-REFERENCES TO RELATED APPLICATION

This application claims priority to Taiwanese Application No. 097101647, filed Jan. 16, 2008, the disclosure of which is herein incorporated by reference.

### BACKGROUND OF THE INVENTION

1. Field of the Invention

This invention relates to a dual-band antenna, more particularly to a dual-band antenna that is of the planar inverted-F (PIF) type.

2. Description of the Related Art

A conventional dual-band wireless local area network (WLAN) antenna that is operable in IEEE 802.11 a/b/g frequency ranges and that is of the planar inverted-F (PIF) type is well known in the art. The conventional dual-band WLAN antenna, however, has a relatively large physical size and a narrow bandwidth. To solve this problem, it has been proposed to use a PIF-type dual-band antenna disclosed in U.S. Pat. No. 6,812,892. The conventional PIF-type dual-band antenna includes a first radiating element that is operable in a first frequency range from 2390 MHz to 2530 MHz, a second radiating element that is operable in a second frequency range from 4840 MHz to 5800 MHz and that is connected to the first radiating element, a feeding element that is connected to a junction of the first and second radiating elements and that is provided with a feeding point, a grounding element that extends from the feeding element, and a coaxial cable that is connected to the feeding point and the grounding element.

The conventional PIF-type dual-band antenna is disadvantageous in that it has a relatively narrow impedance matching bandwidth in the second frequency range.

### SUMMARY OF THE INVENTION

Therefore, the object of the present invention is to provide an antenna that can overcome the aforesaid drawbacks of the prior art.

According to the present invention, an antenna comprises first and second radiating elements and a grounding element. The first radiating element is operable in a first frequency range, and has a feeding end adapted to be coupled to a transceiver of a circuit of an electronic device. The second radiating element is operable in a second frequency range higher than the first frequency range and is connected to the feeding end of the first radiating element. The second radiating element cooperates with the first radiating element so as to define a slot therebetween such that the second radiating element is coupled to the first radiating element to thereby widen a bandwidth of the second frequency range. The grounding element extends from the first radiating element.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of the first preferred embodiment of an antenna according to this invention;

FIG. 2 is a perspective view illustrating first and second radiating elements and a grounding element of the first preferred embodiment;

FIG. 3 is a perspective view illustrating an exemplary application in which the first preferred embodiment is installed in a notebook computer;

FIG. 4 is a perspective view illustrating a current path along the first radiating element of the first preferred embodiment;

FIG. 5 is a perspective view illustrating a current path along the second radiating element of the first preferred embodiment;

FIG. 6 is a perspective view illustrating a current path along the first and second radiating elements of the first preferred embodiment;

FIG. 7 is a schematic view illustrating a copper foil of the first preferred embodiment;

FIG. 8 is a schematic view illustrating a coaxial cable of the first preferred embodiment;

FIG. 9 is a perspective view of the second preferred embodiment of an antenna according to this invention;

FIG. 10 is a plot illustrating a voltage standing wave ratio (VSWR) of the second preferred embodiment;

FIG. 11 shows plots of radiation patterns of the second preferred embodiment respectively on the x-y, x-z, and y-z planes when operated at 2437 MHz; and

FIG. 12 shows plots of radiation patterns of the second preferred embodiment respectively on the x-y, x-z, and y-z planes when operated at 5470 MHz.

### DETAILED DESCRIPTION OF THE PREFERRED EMBODIMENTS

Before the present invention is described in greater detail, it should be noted that like elements are denoted by the same reference numerals throughout the disclosure.

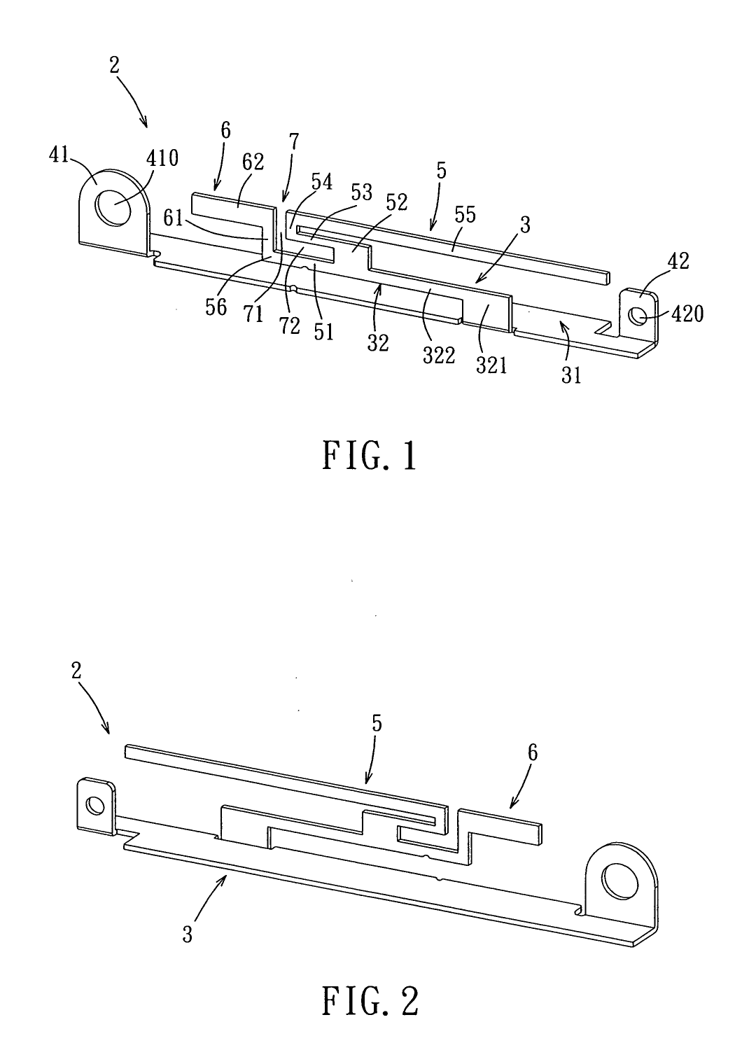

Referring to FIGS. 1 and 2, the first preferred embodiment of an antenna 2 according to this invention is shown to include first and second radiating elements 5, 6 and a grounding element 3.

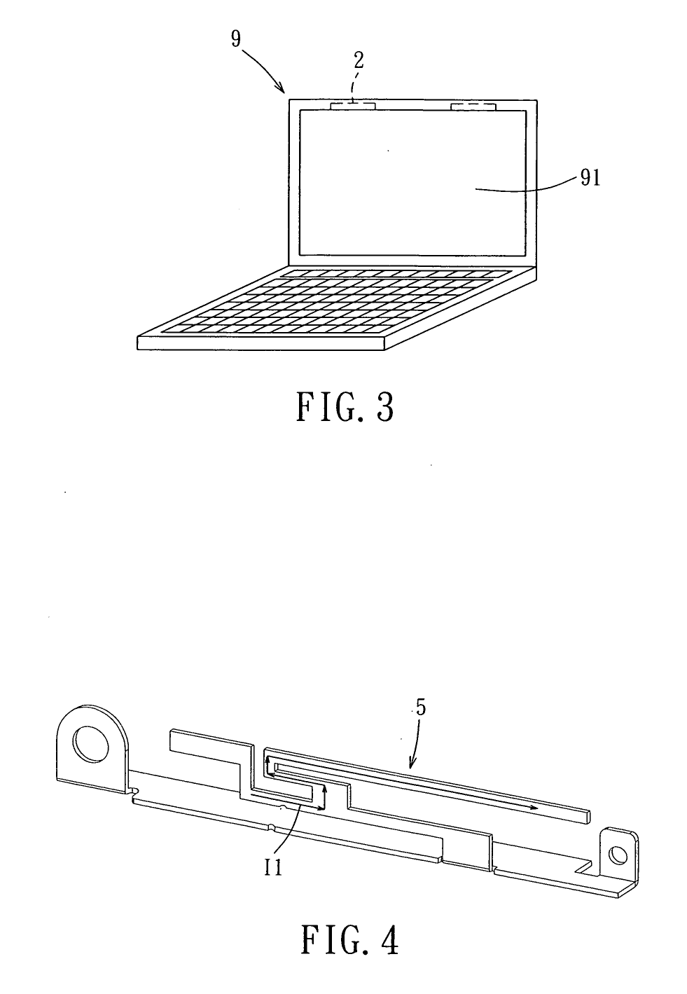

The antenna 2 of this invention, as illustrated in FIG. 3, is installed in an electronic device 9, such as a notebook computer, and is disposed above a display 91 of the electronic device 9.

The first radiating element 5 is operable in a first frequency range from 2400 MHz to 2500 MHz, and has a feeding end 56 coupled to a transceiver (not shown) of a circuit (not shown) of the electronic device 9. In particular, the first radiating element 5 includes first, second, third, fourth, and fifth parts 51, 52, 53, 54, 55. The first part 51 of the first radiating element 5 defines the feeding end 56 of the first radiating element 5, and has a grounding end opposite to the feeding end 56 thereof. The second part 52 of the first radiating element 5 extends transversely from the first part 51 of the first radiating element 5, and has a lower end connected to the grounding end of the first part 51 of the first radiating element 5, and an upper end opposite to the lower end thereof. The third part 53 of the first radiating element 5 extends transversely from the second part 52 of the first radiating element 5, and has a right end connected to the upper end of the second part 52 of the first radiating element 5, and a left end opposite to the right end thereof. The fourth part 54 of the first radiating element 5 extends transversely from the third part 53 of the first radiating element 5, and has a lower end connected to the left end of the third part 53 of the first radiating element 5, and an upper end opposite to the lower end thereof. The fifth part 55 of the first radiating element 5 extends transversely from the fourth part 54 of the first radiating element 5, and has a left end connected to the upper end of the fourth part 54 of the first radiating element 5, and a right end opposite to the left end thereof.

In this embodiment, the first radiating element 5 has a length that may be lengthened or shortened to adjust a bandwidth of the first frequency range.

The second radiating element 6 is operable in a second frequency range from 4900 MHz to 5900 MHz and is connected to the feeding end 56 of the first part 51 of the first radiating element 5. In this embodiment, the second radiating element 6 cooperates with the first radiating element 5 so as to define a slot 7 therebetween such that the second radiating element 6 is coupled to the first radiating element 5 to thereby widen a bandwidth of the second frequency range. In particular, the second radiating element 6 includes first and second parts 61, 62. The first part 61 of the second radiating element 6 extends transversely from the first part 51 of the first radiating element 5, and has a lower end connected to the feeding end 56 of the first part 51 of the first radiating element 5, and an upper end opposite to the lower end thereof. The second part 62 of the second radiating element 6 extends transversely from the first part 61 of the second radiating element 6, and has a right end connected to the upper end of the first part 61 of the second radiating element 6, and a left end opposite to the right end thereof.

In this embodiment, the second radiating element 6 has a length that may be lengthened or shortened to adjust the bandwidth of the second frequency range.

The slot 7 is generally L-shaped, and includes first and second segments 71, 72. The first segment 71 of the slot 7 is defined by the fourth part 54 of the first radiating element 5 and the first part 61 of the second radiating element 6. The second segment 72 of the slot 7 is defined by the first, second, and third parts 51, 52, 53 of the first radiating element 5 and the first part 61 of the second radiating element 6. In this embodiment, the second segment 72 of the slot 7 has a width narrower than that of the first segment 71 of the slot 7.

FIG. 4 illustrates a current path (I1) along the first radiating element 5 when the first radiating element 5 resonates at a first high frequency.

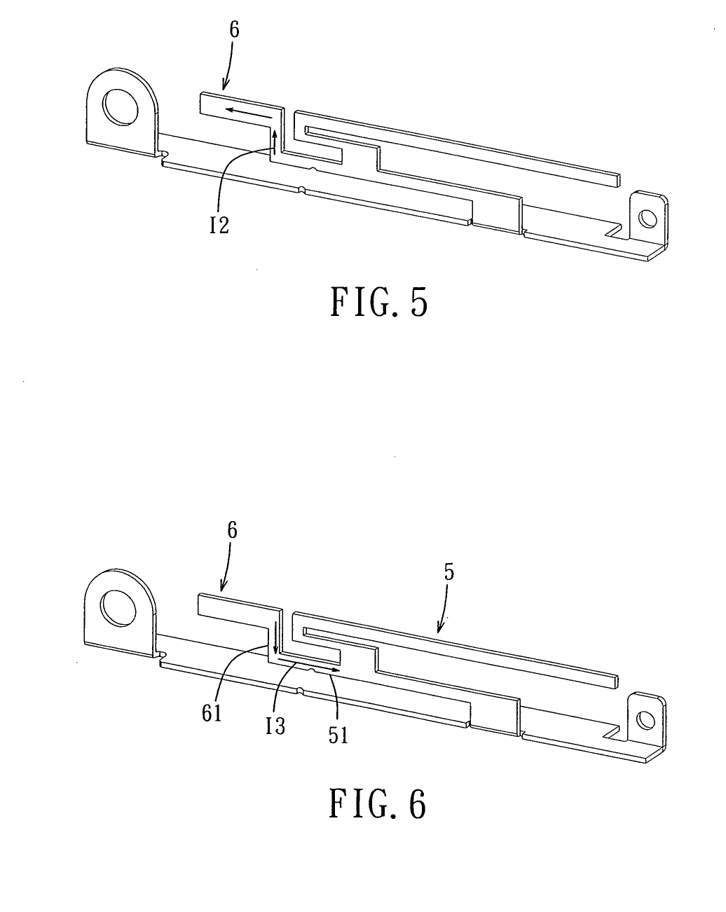

FIG. 5 illustrates a current path (I2) along the second radiating element 6 when the second radiating element 6 resonates at a low frequency.

FIG. 6 illustrates a current path (I3) along the first part 51 of the first radiating element 5 and the first part 61 of the second radiating element 6 when the slot 7 resonates at a second high frequency.

The grounding element 3 includes a main part 31, and an extension 32 that extends between the main part 31 thereof and the first radiating element 5. In particular, as best shown in FIG. 1, the extension 32 of the grounding element 3 is generally L-shaped, and includes first and second parts 321, 322. The first part 321 of the extension 32 extends transversely from the main part 31, and has a lower end connected to the main part 31 at a position between left and right ends of the main part 31, and an upper end opposite to the lower end thereof. The second part 322 of the extension 32 extends transversely from the first part 321 of the extension 32, and has a right end connected to the upper end of the first part 321 of the extension 32, and a left end opposite to the right end thereof and connected to a junction of the grounding end of the first part 51 and the lower end of the second part 52 of the first radiating element 5.

In this embodiment, the first, second, third, fourth, and fifth parts 51, 52, 53, 54, 55 of the first radiating element 5, the first and second parts 61, 62 of the second radiating element 6, and the first and second parts 321, 322 of the extension 32 of the grounding element 3 are flat and are coplanar in a first plane.

The antenna 2 further includes a pair of securing members 41, 42, each of which extends transversely from the main part 31 of the grounding element 3, each of which is connected to a respective one of the left and right ends of the main part 31 of the grounding element 3, and each of which is formed with a hole 410, 420 therethrough for extension of a screw (not shown). The construction as such permits fastening of the antenna 2 of this invention to the electronic device 9 with the use of a pair of screws (not shown).

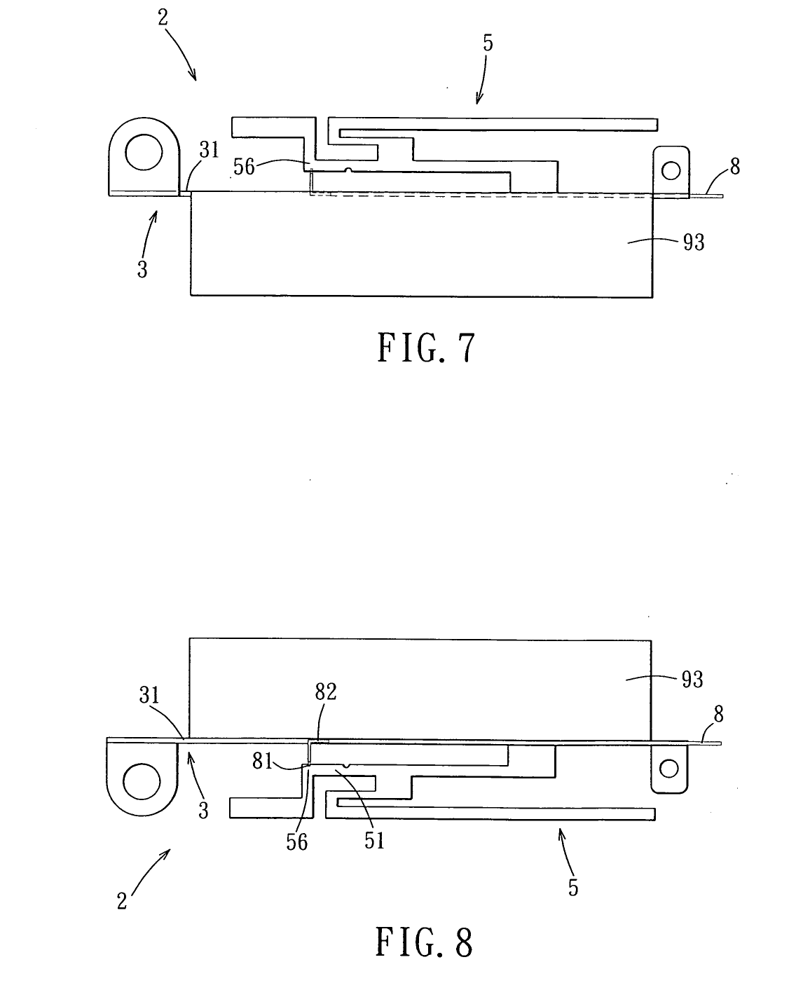

With further reference to FIGS. 7 and 8, the antenna 2 further includes a copper foil 93 and a coaxial cable 8. The copper foil 93 is connected to the main part 31 of the grounding element 3 and an electrical ground (not shown) of the circuit of the electronic device 9. The coaxial cable 8 has positive and negative terminals 81, 82, each of which is coupled to a respective one of the feeding end 56 of the first part 51 of the first radiating element 5 and the main part 31 of the grounding element 3.

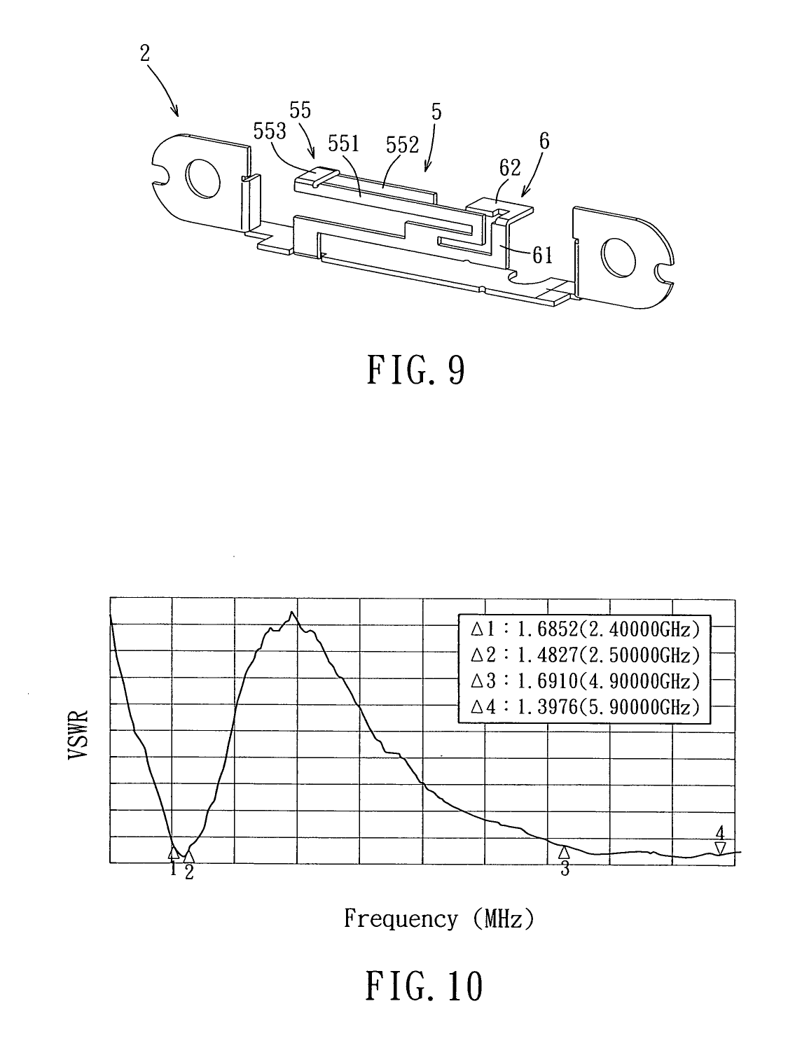

FIG. 9 illustrates the second preferred embodiment of an antenna 2 according to this invention. When compared to the previous embodiment, in this embodiment, the fifth part 55 of the first radiating element 5 has first and second end portions 551, 552, and a middle portion 553 that interconnects the first and second end portions 551, 552 thereof. In this embodiment, the first end portion 551 of the fifth part 55 is flat and lies in the first plane, the middle portion 553 of the fifth part 55 is flat and lies in a second plane transverse to the first plane, and the second end portion 552 of the fifth part 55 is flat and lies in a third plane parallel to the first plane. Furthermore, in this embodiment, the second part 62 of the second radiating element 6 is generally U-shaped and lies in the second plane. The construction as such reduces the physical size of the antenna 2 of this embodiment.

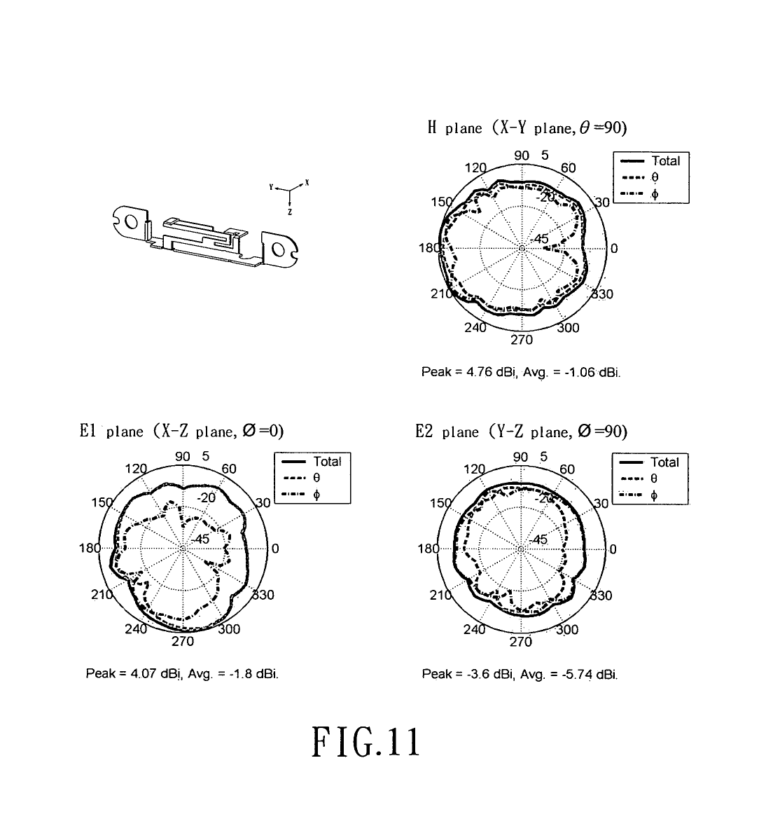

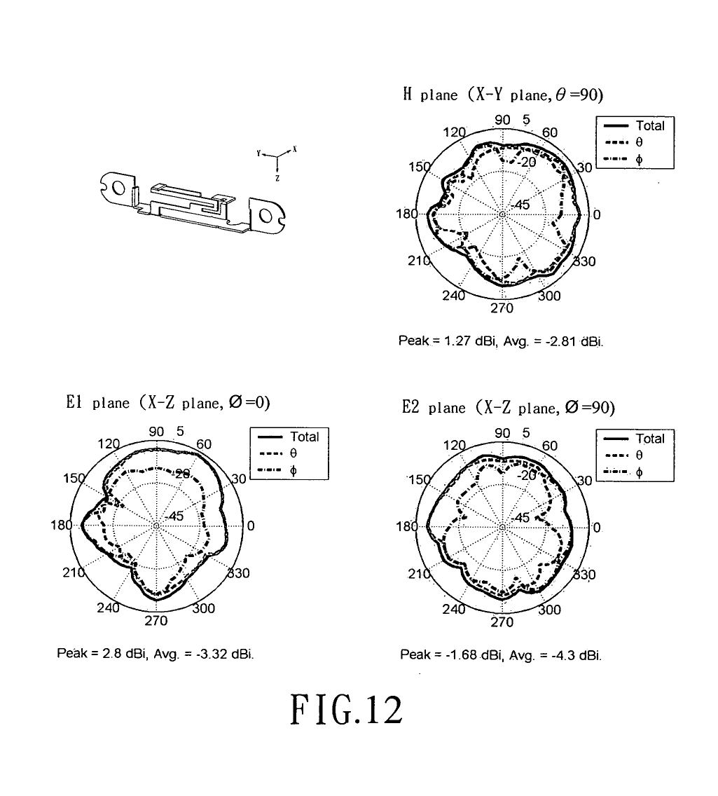

Experimental results, as illustrated in FIG. 10, show that the antenna 2 of this embodiment achieves a voltage standing wave ratio (VSWR) of less than 2.0 when operated in the first and second frequency ranges. Moreover, as shown in Table I below, the antenna 2 of this embodiment has a minimum total radiation power (TRP) of −4.00 dB and a minimum efficiency of 39.78%. Further, as illustrated in FIGS. 11 and 12, the antenna 2 of this embodiment has a substantially omnidirectional radiation pattern when operated at 2437 MHz and 5470 MHz, respectively.

TABLE I

| | | | | H-plane |
|---|---|---|---|---|
| | | | Efficiency | Average |
| Frequency (MHz) | | TRP (dB) | (%) | Gain (dBi) |
| 802.11 b/g | 2412 | −3.06 | 49.40 | −1.23 |
| | 2437 | −2.70 | 53.68 | −1.06 |
| | 2462 | −2.81 | 52.35 | −1.35 |
| 802.11 a | 4900 | −4.00 | 39.78 | −3.77 |
| | 5150 | −3.79 | 41.80 | −2.41 |
| | 5350 | −3.88 | 40.96 | −2.79 |
| | 5470 | −3.61 | 43.56 | −2.81 |
| | 5725 | −3.78 | 41.92 | −2.11 |
| | 5875 | −3.90 | 40.74 | −3.01 |

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An antenna comprising:
a first radiating element operable in a first frequency range, and having a feeding end adapted to be coupled to a transceiver of a circuit of an electronic device;
a second radiating element operable in a second frequency range higher than the first frequency range and connected to said feeding end of said first radiating element, said second radiating element cooperating with said first radiating element so as to define a slot therebetween such that said second radiating element is coupled to said first radiating element to thereby widen a bandwidth of the second frequency range; and
a grounding element extending from said first radiating element.

2. The antenna as claimed in claim 1, wherein said first radiating element includes
a first part that defines said feeding end of said first radiating element,
a second part that extends transversely from said first part,
a third part that extends transversely from said second part,
a fourth part that extends transversely from said third part, and
a fifth part that extends transversely from said fourth part,
said grounding element extending from a junction of said first and second parts of said first radiating element.

3. The antenna as claimed in claim 1, wherein said second radiating element includes a first part that is connected to said feeding end of said first radiating element, and a second part that extends transversely from said first part thereof.

4. The antenna as claimed in claim 1, wherein said first and second radiating elements are flat and are coplanar.

5. The antenna as claimed in claim 2, wherein said first, second, third, and fourth parts of said first radiating element are coplanar in a first plane,
said fifth part of said first radiating element having first and second end portions, and a middle portion that interconnects said first and second end portions thereof, said first end portion of said fifth part being flat and lying in the first plane, said middle portion of said fifth part being flat and lying in a second plane transverse to the first plane, said second end portion of said fifth part being flat and lying in a third plane parallel to the first plane.

6. The antenna as claimed in claim 3, wherein said first part of said second radiating element is flat and lies in a first plane, and said second part of said second radiating element is flat and lies in a second plane transverse to the first plane.

7. The antenna as claimed in claim 2, wherein said slot is generally L-shaped, and includes a first segment defined by said fourth part of said first radiating element and said second radiating element, and a second segment defined by said first and third parts of said first radiating element.

8. The antenna as claimed in claim 3, wherein said slot is generally L-shaped, and includes first and second segments defined by said first radiating element and said first part of said second radiating element.

9. The antenna as claimed in claim 2, wherein said second radiating element includes a first part that extends transversely from said first part of said first radiating element and that is connected to said feeding end of said first part of said first radiating element, and a second part that extends transversely from said first part thereof.

10. The antenna as claimed in claim 9, wherein said slot is generally L-shaped, and includes a first segment defined by said fourth part of said first radiating element and said first part of said second radiating element, and a second segment defined by said first and third parts of said first radiating element.

11. The antenna as claimed in claim 1, wherein said grounding element includes
a main part, and
an extension that extends between said main part thereof and said first radiating element.

12. The antenna as claimed in claim 11, further comprising a securing member extending from said main part of said grounding element.

13. The antenna as claimed in claim 12, wherein said securing member is formed with a hole therethrough for extension of a screw.

14. The antenna as claimed in claim 11, further comprising a copper foil coupled to said main part of said grounding element and adapted to be coupled to an electrical ground of the circuit of the electronic device.

15. The antenna as claimed in claim 11, further comprising a coaxial cable having positive and negative terminals, each of which is coupled to a respective one of said feeding end of said first radiating element and said main part of said grounding element.

16. The antenna as claimed in claim 1, wherein the first frequency range is from 2400 MHz to 2500 MHz.

17. The antenna as claimed in claim 1, wherein the second frequency range is from 4900 MHz to 5900 MHz.
